(19) United States
(12) Patent Application Publication
(10) Pub. No.: US 2011/0048561 A1
(43) Pub. Date: Mar. 3, 2011

(54) Zero-pitch pipe

(76) Inventor: Stacey L. Marotta, Chester, NJ (US)

(21) Appl. No.: 12/585,072

(22) Filed: Sep. 2, 2009

(51) Int. Cl. F16K 1/32

(52) U.S. Cl. 137/614.2

(57) ABSTRACT

A pipe is provided through which a fluid can move without backflow in the absence of a gravity force provided by a downward pitch. This is accomplished by providing within the pipe a series of one-way valves, each having a structure similar to a mitral valve, with a rigid upper flap cooperating with a semi-rigid but flexible lower flap. Fluid pressure upstream of the valve will displace the lower flap enough to allow fluid to accumulate in a reservoir area downstream of the valve and upstream of a ramp structure. When sufficient fluid accumulates in the reservoir area, it overflows the ramp structure and proceeds to the next one-way valve, and the process is repeated.

### BACKGROUND OF THE INVENTION

The present invention relates to the field of pipes for conveying fluids, and more particularly to a type of pipe through which a fluid will flow without the force of gravity, as when a pipe is installed with no downward pitch.

The present invention comprises a pipe through which a fluid can move without backflow in the absence of a gravity force provided by a downward pitch. This is accomplished by providing within the pipe a series of one-way valves each having a structure similar to a mitral valve, with a rigid upper flap cooperating with a semi-rigid but flexible lower flap. Fluid pressure upstream of the valve will displace the lower flap enough to allow fluid to accumulate in a reservoir area downstream of the valve and upstream of a ramp structure. When sufficient fluid accumulates in the reservoir area, it overflows the ramp structure and proceeds to the next one-way valve, and the process is repeated.

U.S. Pat. No. 4,989,760 to Songzeng, describes a self-filling siphon pipe which comprises a series of internal one-way valves. But the Songzeng device relies on the suction force from a siphon hose to move liquid through the pipe, whereas the present invention requires no fluid transport force beyond the passive fluid pressure in the pipe.

U.S. Pat. No. 3,855,995 to Bentley describes a blood pumping assembly in which a series of leaflet-type valves are used in conjunction with a ramp-like structure to provide passive flow of blood through the device. But the valve structure is dissimilar to the present invention insofar as it lacks the asymmetrical flexibility of the valve. Also, fluid movement through the assembly is ultimately dependent on the external force provided by a pump.

U.S. Pat. No. 6,089,260 to Jaworski et al. describes nested duckbill check valve system for back-flow prevention used in conduits such as garden hose nozzles. While this design has serial one-way check valves, it provides no mechanism for passive fluid flow and thus would not be applicable to a zero-pitch pipe.

### SUMMARY OF THE INVENTION

The present invention comprises a tubular pipe fabricated of durable metal or plastic. Within the pipe are a series of one-way valves, with each valve comprising a rigid upper flap and a semi-rigid, flexible lower flap. The upper flap is preferably concave and the lower flap is preferably flat. The upper flap is rigidly attached to the upper interior surface of the pipe, while the lower flap is rigidly attached to the lower interior surface of the pipe.

Downstream of each one-way valve is a ramp structure that has a forward slope and a rear slope. The forward slope is less steeply inclined than the rear slope. The ramp structure is fabricated of rigid metal or plastic and is rigidly attached to the lower interior surface of the pipe.

When a fluid flow within the pipe encounters one of the one-way valves, the pressure of the fluid causes the valve's lower flap to bend downward, thus allowing the fluid to fill the back reservoir until it overflows the rear slope of the ramp structure and flows down the forward slope into the front reservoir.

The fluid accumulates in the front reservoir until the fluid pressure causes the lower flap of the next one-way valve to bend downward, and the flow process described above is repeated. In this way, a fluid can flow from one end of the pipe to the other without the aid of gravity.

Optionally, the one-way valves can be eliminated, such that the fluid flow through the pipe is controlled by the ramp structures alone.

### BRIEF DESCRIPTION OF THE DRAWINGS

FIG. 1 is a longitudinal cross-section view of the preferred embodiment of the present invention.

FIG. 2 is a transverse cross-section view of the preferred embodiment of the present invention along the line 2-2 shown in FIG. 1.

### DETAILED DESCRIPTION OF THE PREFERRED EMBODIMENT

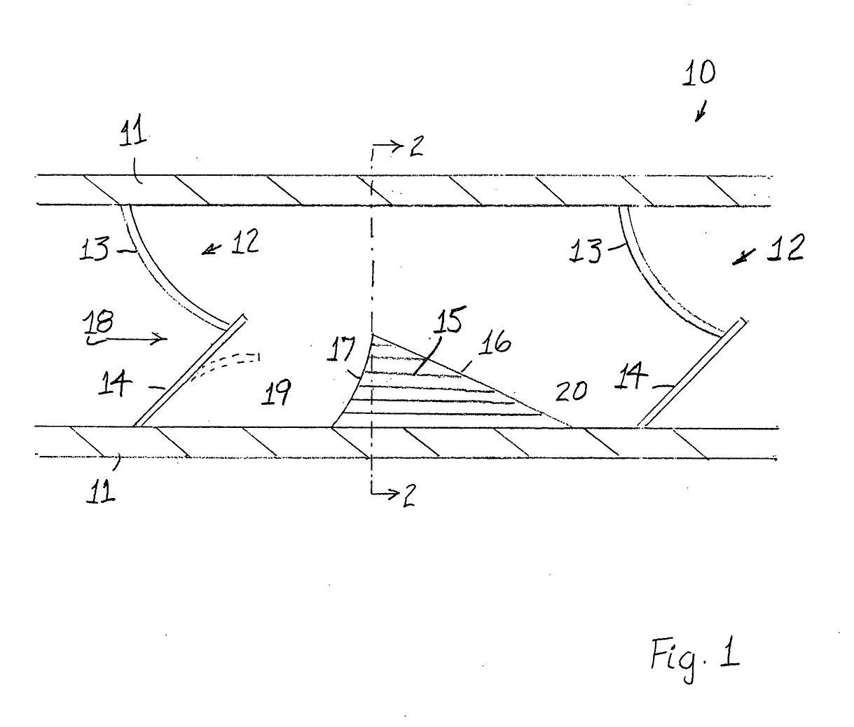

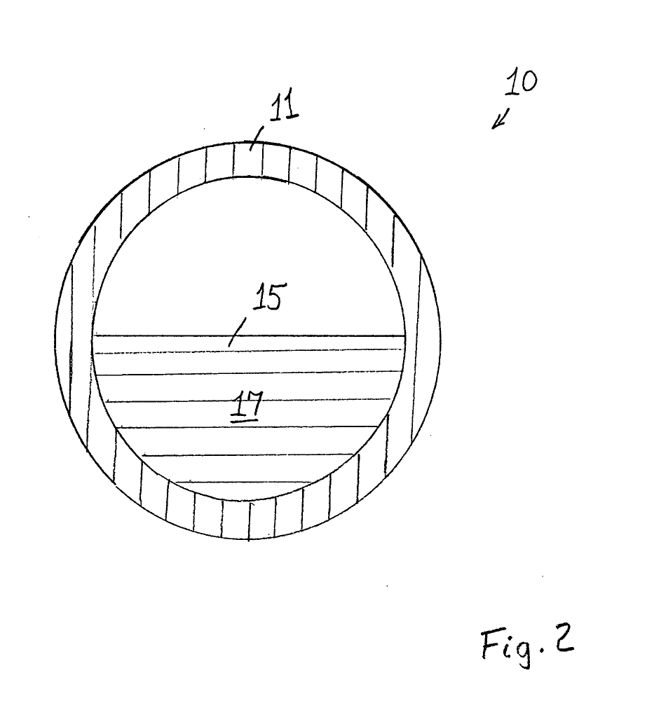

Referring to FIGS. 1 and 2, the present invention 10 comprises a tubular pipe 11 fabricated of durable metal or plastic. Within the pipe 11 are a series of one-way valves 12, with each valve comprising a rigid upper flap 13 and a semi-rigid, flexible lower flap 14. The upper flap 13 is preferably concave and the lower flap 14 is preferably flat. The upper flap 13 is rigidly attached to the upper interior surface of the pipe 11, while the lower flap 14 is rigidly attached to the lower interior surface of the pipe 11.

Downstream of each one-way valve 12 is a ramp structure 15 that has a forward slope 16 and a rear slope 17. The forward slope 16 is less steeply inclined than the rear slope 17. The ramp structure 15 is fabricated of rigid metal or plastic and is rigidly attached to the lower interior surface of the pipe 11.

When a fluid flow 18 within the pipe 11 encounters one of the one-way valves 12, the pressure of the fluid 18 causes the valve's lower flap 14 to bend downward, thus allowing the fluid 18 to fill the back reservoir 19 until it overflows the rear slope 17 of the ramp structure 15 and flows down the forward slope 16 into the front reservoir 20.

The fluid 18 accumulates in the front reservoir 20 until the fluid pressure 18 causes the lower flap 14 of the next one-way valve 12 to bend downward, and the flow process described above is repeated. In this way, a fluid can flow from one end of the pipe 11 to the other without the aid of gravity.

Although the preferred embodiment of the present invention has been disclosed for illustrative purposes, those skilled in the art will appreciate that many additions, modifications and substitutions are possible, without departing from the scope and spirit of the present invention.

What is claimed is:

1. A pipe comprising:
(a) a tubular wall enclosing an interior volume, which interior volume is transversely divisible into multiple circular cross-sections and longitudinally divisible into a semi-cylindrical upper volume and a semi-cylindrical lower volume;
(b) within the interior volume, a series of one-way valves, each valve extending across one of the cross-sections, and each valve comprising two overlapping, cooperating duck-billed or mitral valve flaps;
(c) between the valves, a series of ramp structures, each ramp structure extending within the lower volume across a portion of one of the cross-sections, and each ramp structure have an inclined rear slope facing a preceding valve and an inclined forward slope facing a succeeding valve;
(d) between each rear slope and each preceding valve, a back reservoir, containing a portion of the lower volume; and
(e) between each forward slope and each succeeding valve, a front reservoir, containing a portion of the lower volume.

2. The pipe according to claim 1, wherein one of the valve flaps is an upper flap extending within the upper volume across a portion of one of the cross-sections, and the other valve flap is a lower flap extending within the lower volume across a portion of one of the cross-sections.

3. The pipe according to claim 2, wherein the upper flap is rigid, while the lower flap is semi-rigid and capable of bending downward in the direction of the rear slope of the ramp structure, thereby creating an opening between the upper flap and lower flap through which a fluid can flow into the back reservoir.

4. The pipe according to claim 3, wherein the rear slope of each ramp structure is inclined more steeply than the forward slope.

5. A pipe comprising:
(a) a tubular wall enclosing an interior volume, which interior volume is transversely divisible into multiple circular cross-sections and longitudinally divisible into a semi-cylindrical upper volume and a semi-cylindrical lower volume;
(b) within the interior volume, a series of ramp structures, each ramp structure extending within the lower volume across a portion of one of the cross-sections, and each ramp structure have an inclined rear slope facing a preceding ramp structure and an inclined forward slope facing a succeeding ramp structure;
(c) between each rear slope and each preceding ramp structure, a back reservoir, containing a portion of the lower volume; and
(d) between each forward slope and each succeeding ramp structure, a front reservoir, containing a portion of the lower volume.

6. The pipe according to claim 5, wherein the rear slope of each ramp structure is inclined more steeply than the forward slope.
